(19) United States
(12) Patent Application Publication
(10) Pub. No.: US 2024/0288992 A1
(43) Pub. Date: Aug. 29, 2024

(54) Adaptive User Interface for Marine Electronic Device Usability

(71) Applicant: Navico, Inc., Tulsa, OK (US)

(72) Inventors: Paul Robert Bailey, Auckland (NZ); Alan Van Gerve, Auckland (NZ)

(21) Appl. No.: 18/174,913

(22) Filed: Feb. 27, 2023

(51) Int. Cl. G06F 3/0482; B63B 49/00; G06F 3/01

(52) U.S. Cl. CPC G06F 3/0482; G01S 7/56; B63B 49/00; G01S 15/89; G06F 3/017; G06F 2203/04108; G06F 2203/04803; G06F 2203/04804

(57) ABSTRACT

Systems and methods for presenting marine data are provided herein. The system comprises a sensor, a display, at least one processor, and computer program code. The computer program code is configured to, when executed by the at least one processor, cause, on the display, presentation of at least one image. The at least one image covers a first area of the display extending at least partially across the display. The computer program code further determines, based on data from the sensor, a presence of a user within a sensing zone. The computer program code further causes, on the display, in response to detecting the presence of the user within the sensing zone, an interactive menu to be presented within at least a portion of the first area of the display.

### FIELD

Embodiments of the present invention relate generally to presentation of marine data and interaction with marine electronic device(s), and more particularly to, providing for an improved user interface and experience for presenting display features on a marine electronic device.

### BACKGROUND

Marine electronic devices are used to present marine data, and other types of data to a user while using a marine watercraft. With technological improvements, more types of data are available to be collected and the amount of data collected has increased. Thus, to present all available data, the display abilities and functionality of the marine electronic devices has similarly increased. In order to present the data, menus, and other command centers are added onto the display area, effectively causing the functional visual area of the display to decrease in size.

As a consequence of the increased data collection and presentation, the marine electronic devices require a greater amount of energy. In this regard, to increase the functional life of the marine electronic device (e.g., battery life), the marine electronic devices may employ power saving features while on the watercraft. This, of course, should be balanced with desirable access for a user.

Thus, there exists a need to allow effective presentation of data (e.g., in charts, and/or images), while maintaining functionality of utilizing menus and optionality for switching between multiple display pages to see/use the different options. Further, with the increased functionality, methods to reserve the battery life of the marine electronic device while maintaining the functionality of the device is desired.

### BRIEF SUMMARY OF THE INVENTION

As noted above, it can be difficult to present all of the marine data gathered during the course of a trip on the display of a marine electronic device. Even with the improvements in the sizes of the display, there is a desire to see the current image, chart, or screen across the whole display. However, the added functionality including menus, toggle screens, data display and other options may take up space on the display, thereby preventing the user from seeing the entire image on the display. Notably, marine electronic devices are often used as aids by presenting the marine data while a user engages in other marine activities (e.g., fishing, driving, etc.) and, thus, maximizing the functional visual display space is important (such as making the sonar image as large as possible to enable the user to see the fish).

Various embodiments of the present invention use sensors to determine when a user wishes to “interact” with the display. In some such embodiments, an interactive menu (which is used to access the various vast functionality of the marine electronic device) can be hidden until the sensor(s) detect a user (at which time the interactive menu can be presented on the display for use thereof). This allows the functional visual display space to be used for presenting the desirable marine data instead, and the interactive menu is only presented when needed. Accordingly, various embodiments of the present invention utilize sensor(s) to detect the presence of a user, and in response to detecting the presence of the user, adjust the presentation of the display, such as by adding one or more interactive menus. In some embodiments, a proximity sensor may be used to determine when a user is close to a sensing zone of the display. In some embodiments, based on the user's position within the sensing zone, different menus or options may be presented on the display for the user to select. Further, the sensor may be configured to engage or disengage a power save mode based on the position of the user within the sensing zone. In some embodiments, a camera or other sensor type device may be used.

In an example embodiment a system for presenting marine data is provided. The system comprises a sensor, a display, at least one processor and a memory including a computer program code. The computer program code is configured to, when executed, cause the at least one processor to cause, on the display, presentation of at least one image. The at least one image covers a first area of the display which extends at least partially across the display. The computer program code is further configured to cause the processor to detect, with the sensor, a presence of a user within a sensing zone, and to cause, on the display, in response to detecting the presence of the user within the sensing zone, an interactive menu to be presented within at least a portion of the first area of the display, wherein the interactive menu was not previously presented within the portion of the display.

In some embodiments, the sensor may be a proximity sensor. In some embodiments, the interactive menu may be presented over the at least one image. In some embodiments, the computer program code may be further configured to, when executed, cause the at least one processor to cause, on the display, presentation of the at least one image to be reduced to a second area, the second area being smaller than the first area. The second area and the at least a portion of the first area of the display presenting the interactive menu may not overlap.

In some embodiments, the at least a portion of the first area may be an edge of the display. In some embodiments, the at least a portion of the first area may be a top edge of the display. In some embodiments, the at least a portion of the first area may be a first side edge and a second side edge of the display.

In some embodiments, the at least one image may be a first image and a second image. The first image may cover a third area of the display, and the second image may cover a fourth area of the display. The interactive menu may be presented within either a first portion of the third area of the display, a second portion of the fourth area of the display or both the first portion of the third area and the second portion of the fourth area of the display.

In some embodiments, the interactive menu may be a first interactive menu and a second interactive menu. The computer program code may be configured to, when executed cause the at least one processor to cause, on the display, in response to detecting the presence of the use in a first sensing region, presentation of the first interactive menu, to be presented within a first portion of the first area. The computer program code may be further configured to cause, on the display, in response to detecting the presence of the user in a second sensing region, presentation of the second interactive menu, to be presented within a second portion of the first area. The first sensing region, may be different than the second sensing region.

In some embodiments, the sensing zone may be a first sensing zone and a second sensing zone wherein the first sensing zone is a first distance away from the display, and the second sensing zone is a second distance away from the display. The first distance and the second distance being different. The computer program code may be further configured to, when executed, cause the processor to cause, on the display, in response to detecting the presence of the user within the first sensing zone, presentation of an interactive menu indication. The computer program code may be further configured to, when executed, cause the processor to cause, on the display, in response to detecting the presence of the user within the second sensing zone, presentation of the interactive menu.

In some embodiments, the presence of the user may comprise a user gesture. In some embodiments, the computer program code may be further configured to, when executed, cause the at least one processor to cause, on the display, in response to detecting non-presence of the user, presentation of the interactive menu to cease of the portion of the first area of the display.

In another example embodiment a method of presenting marine data is provided. The method comprises causing, on a display, presentation of at least one image which covers a first area of the display. The first area of the display extends at least partially across the display. The method continues by detecting, with a sensor, presence of a user within a sensing zone. The method continues by causing, on the display, in response to detecting the presence of the user within the first sensing zone an interactive menu to be presented within the at least a portion of the first area of the display, wherein the interactive menu war not previously presented within the portion of the first area of the display.

In some embodiments, the sensor may be a proximity sensor. In some embodiments, the interactive menu may be partially transparent. In some embodiments, the presentation of the at least one image may be reduced to a second area upon presentation of the interactive menu on the display in the portion of the first area. The second area and the portion of the first area may be distinct. Ise the at least a portion of the first area may be an edge of the display.

In some embodiments, the at least one image may be a first image and a second image. The first area may be a third area and a fourth area. The first image may be presented within the third area and the second area may be presented within the fourth area. The interactive menu may be presented in either a first portion of the third area, a second portion of the fourth area or both the first portion of the third area and the second portion of the fourth area.

In some embodiments, the sensing zone may be a first sensing region and a second sensing region. The method may further comprise causing, on the display, in response to detecting the presence of the user in the first sensing region, presentation of a first interactive menu within a first portion of the first area of the display. The method may further comprise causing, on the display, in response to detecting the presence of the user in the second sensing region, presentation of a second interactive menu within a second portion of the first area of the display. The first portion and the second portion may be distinct.

In yet another example embodiment a system for presenting marine data is provided. The system comprises a user input device, a display, at least one processor, and a memory including a computer program code. The computer program code is configured to, when executed, cause the at least one processor to cause, on the display, presentation of at least one image, which covers a first area of the display, which extends at least partially across the display. The computer program code is further configured to, when executed, cause the at least one processor to receive, from the user input device, indication of a user engaging the user input device, and cause, on the display, in response to engaging the user input device, an interactive menu to be presented within at least a portion of the first area of the display, wherein the interactive menu was not previously presented within the portion of the first area of the display.

In some embodiments, the user input device may be a button. In some embodiments, the user input device may be a remote. In some embodiments, the interactive menu ay be presented as an overlay of the at least one image.

In yet another example embodiment a system for presenting marine data is provided. The system comprises a display, a camera, at least one processor, and a memory including a computer program code. The camera is user-facing such that a lens of the camera is oriented outwardly from the display towards a direction to capture a user attempting to interact with the display. The computer program code is configured to, when executed, cause the at least one processor to cause, on the display, presentation of at least one image, which covers a first area of the display, which extends at least partially across the display. The computer program code is further configured to, when executed, cause the at least one processor to detect, with the camera, a presence of the user within a sensing zone, and cause, on the display, in response to detecting the presence of the user within the sensing zone, an interactive menu to be presented within at least a portion of the first area of the display, wherein the interactive menu was not previously presented within the portion of the first area of the display.

In some embodiments, the computer program code may be further configured to, when executed, cause the at least one processor to, detect, with the camera, a distance of the user from the display, and cause, on the display, in response to a detected distance of the user, a display action. The display action may be one of: turning off the display, waking up the display, presenting the interactive menu on the display, or locking the display. In some embodiments, the computer program code may be further configured to, when execute, cause the at least one processor to, detect, with the camera, a gesture of the user, and cause, on the display, in response to detecting the gesture of the user, an action to be taken on the display. The action may be one of: selecting the interactive menu, selecting an option from the interactive menu, removing the interactive menu, or locking the display. In some embodiments, the camera may be remote from the display.

In yet another embodiment a method for presenting marine data is provided. The method comprises causing, on a display, presentation of at least one image. The at least one image covering a first area of the display, which extends at least partially across the display. the method further comprises detecting, with the camera, a presence of the user within the sensing zone. The camera is user-facing such that a lens of the camera is oriented outwardly from the display towards a direction to capture a user attempting to interact with the display. The method further comprises causing, on the display, in response to detecting the presence of the user within the sensing zone, an interactive menu to be presented within at least a portion of the first area of the display, wherein the interactive menu was not previously presented within the portion of the first area of the display.

In some embodiments, the method may further comprise detecting, with the camera, a distance of the user from the display, and causing, on the display, in response to a detected distance of the user, a display action. The display action may be one of turning off the display, waking up the display, presenting the interactive menu on the display or locking the display.

### BRIEF DESCRIPTION OF THE DRAWINGS

Reference will now be made to the accompanying drawings, which are not necessarily drawn to scale, and wherein:

FIG. 1 illustrates an example watercraft including various marine devices, in accordance with some embodiments discussed herein;

FIG. 2 illustrates an example marine electronic device including a display presenting a navigational chart and various menus, in accordance with some embodiments discussed herein;

FIG. 3A illustrates the example marine electronic device presenting a navigational chart, wherein the navigational chart is presented across the entire functional visual display space, in accordance with some embodiments discussed herein;

FIG. 3B illustrates the example marine electronic device presenting the navigational chart and interactive menus, in accordance with some embodiments discussed herein;

FIG. 3C illustrates the example marine electronic device presenting the navigational chart and an example interactive menu, in accordance with some embodiments discussed herein;

FIG. 3D illustrates the example marine electronic device presenting the navigational chart and an example interactive menu, in accordance with some embodiments discussed herein;

FIGS. 4A-E illustrate an example marine electronic device having multiple sensing regions within the sensing zone, in accordance with some embodiments discussed herein;

FIG. 5A illustrates an example marine electronic device presenting multiple images, defining multiple sensing zones, in accordance with some embodiments discussed herein;

FIG. 5B illustrates the example marine electronic device presenting multiple images and multiple interactive menus, in accordance with some embodiments discussed herein;

FIG. 5C illustrates the example marine electronic device presenting a first interactive menu in a first sensing zone, in accordance with some embodiments discussed herein;

FIG. 5D illustrates the example marine electronic device presenting a second interactive menu in a second sensing zone, in accordance with some embodiments discussed herein;

FIGS. 6A-D illustrate the marine electronic device and presentation of example interactive menus at different distances from the sensing zone, in accordance with some embodiments discussed herein;

FIGS. 7A-C illustrate power stages of the marine electronic device while a user is at various positions within the watercraft, in accordance with some embodiments discussed herein;

FIG. 8 illustrates a block diagram of an example system with various electronic devices, marine devices, and secondary devices shown, in accordance with some embodiments discussed herein;

FIG. 9 illustrates a flowchart of an example method of presenting an interactive menu on an example display, in accordance with some embodiments discussed herein; and

FIG. 10 illustrates a flowchart of an example method of presenting an interactive menu on an example display, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals refer to like elements throughout.

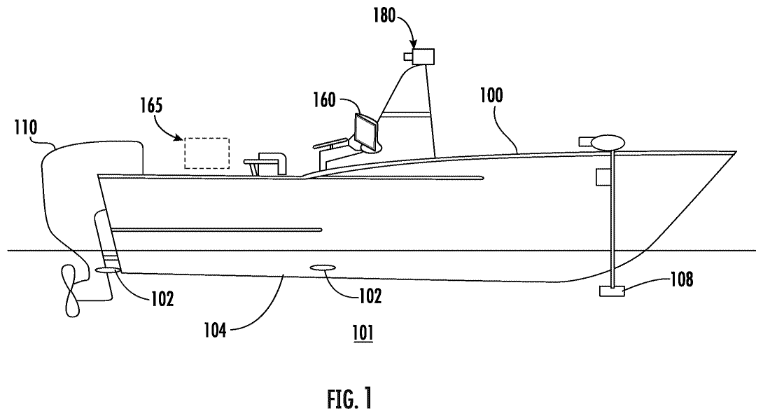

FIG. 1 illustrates an example watercraft 100 including various marine devices, in accordance with some embodiments discussed herein. As depicted in FIG. 1, the watercraft 100 (e.g., a vessel) is configured to traverse a marine environment, e.g., body of water 101, and may use one or more sonar transducer assemblies 102 disposed on and/or proximate to the watercraft. Notably, the example watercraft 100 contemplated herein may be a surface watercraft, a submersible watercraft, or any other implementation known to those skilled in the art. The transducer assemblies 102 may each include one or more transducer elements configured to transmit sound waves into a body of water, receive sonar returns from the body of water, and convert the sonar returns into sonar return data. Various types of sonar transducers may be provided—for example, a linear downscan sonar transducer, a conical downscan sonar transducer, a sonar transducer array, an assembly with multiple transducer arrays, or a sidescan sonar transducer may be used, among others.

Depending on the configuration, the watercraft 100 may include a primary motor 106, which may be a main propulsion motor such as an outboard or inboard motor. Additionally, the watercraft 100 may include a trolling motor 108 configured to, for example, propel the watercraft 100 and/or maintain a position.

The watercraft 100 may also include one or more marine electronic devices 160, such as may be utilized by a user to interact with, view, or otherwise control various functionality regarding the watercraft, including, for example, nautical charts and various sonar systems. In the illustrated embodiment, the marine electronic device 160 is positioned proximate the helm (e.g., steering wheel) of the watercraft 100—although other places on the watercraft 100 are contemplated. Likewise, additionally or alternatively, a user input device 165 (such as a remote, or a user's mobile device) may include functionality of a marine electronic device. In some embodiments, a camera 180 may be a remote device, while in other embodiments the camera 180 may be integral to the marine electronic device 160.

The watercraft 100 may also comprise other components, such as within the one or more marine electronic devices 160 or at the helm. In FIG. 1, the watercraft 100 comprises the camera 180, which is mounted at an elevated position (although other positions relative to the watercraft are also contemplated). In some embodiments, the camera 180 may be user-facing such that it is pointed in a direction where a user interacting with the marine electronic device 160 is. In some embodiments, the watercraft 100 (and/or marine electronic device 160) may include a proximity sensor that may, for example, detect the presence of a user attempting to interact with the marine electronic device 160. In some embodiments, the watercraft 100 may also comprise an AIS transceiver and/or a direction sensor, and these components may be positioned at or near the helm (although other positions relative to the watercraft are also contemplated). In other embodiments, these components may be integrated into the one or more electronic devices 160 or other devices. Other example devices include a wind sensor, one or more speakers, and various vessel devices/features (e.g., doors, bilge pump, fuel tank, etc.), among other things. Additionally, one or more sensors may be associated with marine devices; for example, a position sensor may be provided to detect the position of various marine devices individually.

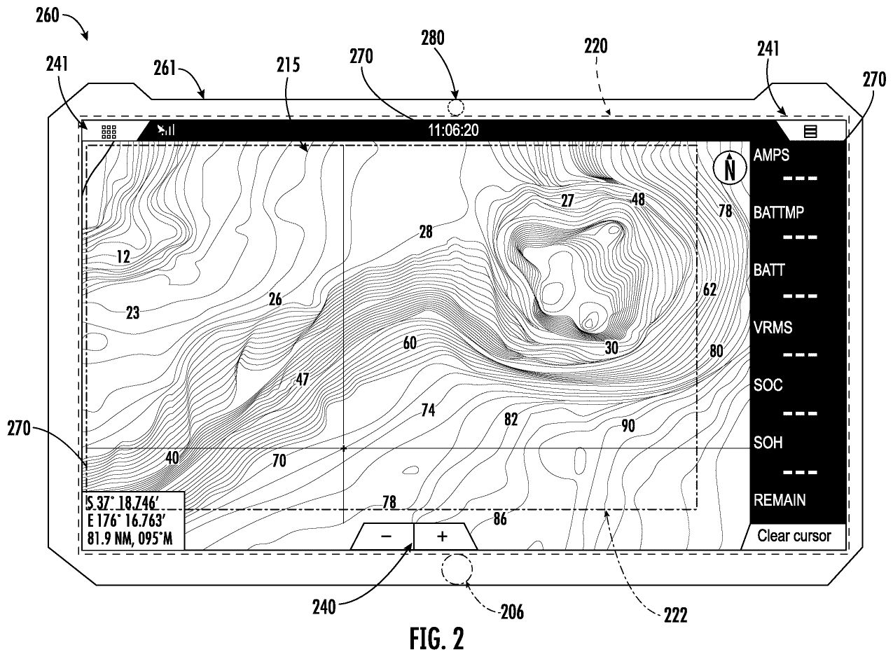

FIG. 2 illustrates an example display 261 of a marine electronic device 260. The display 261 depicts an image 215 of a navigational chart. Although image 215 is depicted as a navigational chart, it should be understood that the at least one image may be any image presented by the marine electronic device, such as, for example, a sonar image, a radar image, a forecast, etc. Further, the image 251 may be more than one image.

In some embodiments, the marine electronic device 260 may include a user input device 206. The user input device 206 may be configured to select options from menus, toggle between screens, or similar. In some embodiments, the user input device 206 may be a button integral to the display 261. In other embodiments, the user input device 206 may be a remote device, for example, a cellular device (e.g., 165 FIG. 1). In some embodiments, the display 261 may be a touch screen such that when a user touches an area on the display 261, an action may be taken. As will be discussed herein, the sensitivity (e.g., easy of selecting) may be affected by the location of the user based on a determination by the sensor, such as, for example, a proximity sensor.

In some embodiments, the marine electronic device 260 may include a camera 280 associated with (e.g., near, pointed toward, and/or embedded within) the display 261. In some embodiments, the camera 280 may be remote to the marine electronic device 260 while maintaining data communication between the camera 280 and the marine electronic device 260. The camera 280 may be a user-facing camera. In this regard, the camera 280 may face outward from the display 261 in a direction of the user of the marine electronic device 260.

In some embodiments, the display 261 may have a display area 220 including the total useable space (e.g., functional visual display space) for presenting information on the display 261. In the illustrated embodiment, an image 215, marine data 270 (e.g., marine electronic device data, heading and location data, time data, wireless internet status, etc.), an interactive menu indication 241 (grid view, list view, compass, etc.), and an interactive menu 240 (e.g., zoom level) are all illustrated within the display area 220. Each of these options takes up a portion of what would be useable display area 220 to present information that may be desirable for being seen by the user at all times.

Thus, all of the “extras” (e.g., interactive menus 240, interactive menu indication 241 and marine data 270) take up space on the display 261 which otherwise could be used to show more of the image 215 presented on the display 261. To explain, rather than the at least one image 215 covering the entire display area 220, the image 215 is only viewable in a reduced area 222. Thus, although there is more useable space within the display 261, the display area 220 is not fully utilized by the image 215, but also includes dead (or already covered) space due to the marine data 270, the interactive menu indication 241 and the interactive menu 240. Here, the reduced area 222 is about 20% less than the display area 220, and, therefore, the image 215 only includes about 80% of the relevant image.

In addition to reducing the amount of space about the display area 220, the interactive menu indications 241, the interactive menus 240 and the marine data 270 may cover portions of the image 215 which may be useful to the user. For example, when the image 215 is a sonar image, any of the interactive menus 240, interactive menu indications 241, or the marine data 270 may be presented within the display area 220 and cover a shadow, or an indication of a fish, hazard, or point of interest within the marine environment.

Thus, to increase the amount of space available on the display, the marine electronic device may comprise a sensor to determine the presence of a user and present one or more interactive menus (which may include interactive menu indications or other marine data) on the display.

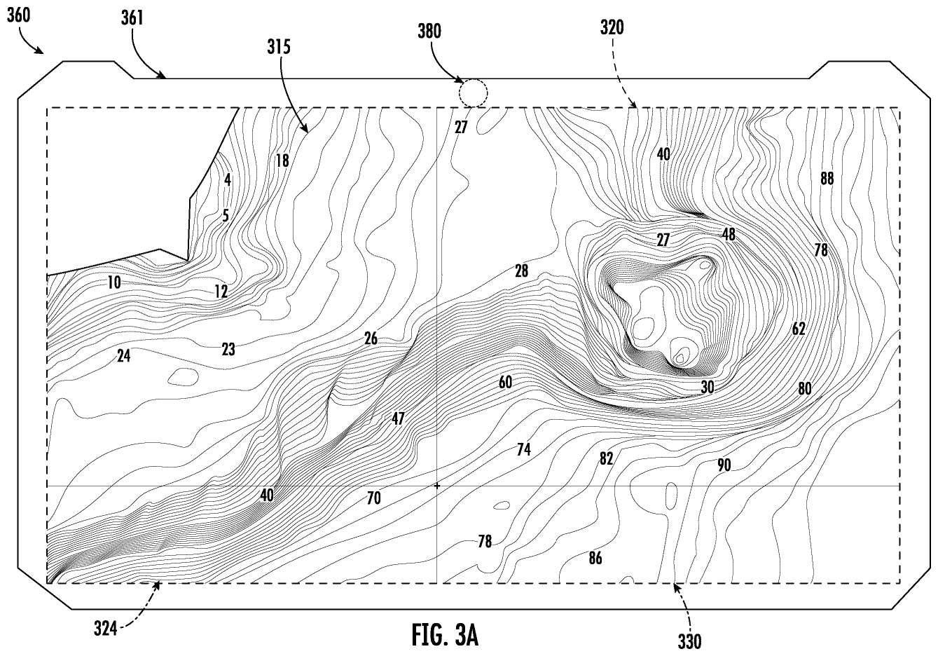

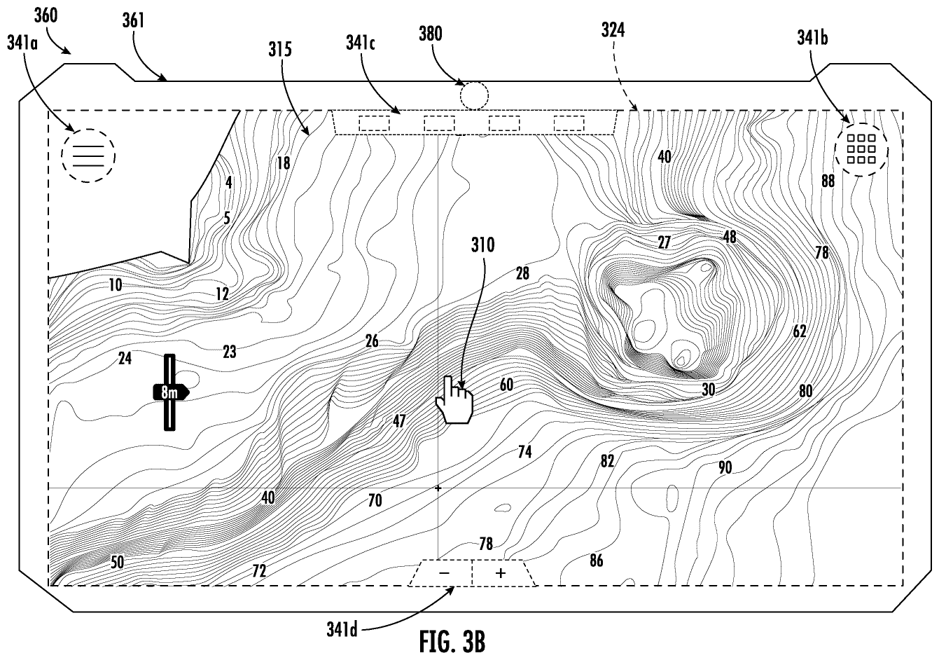

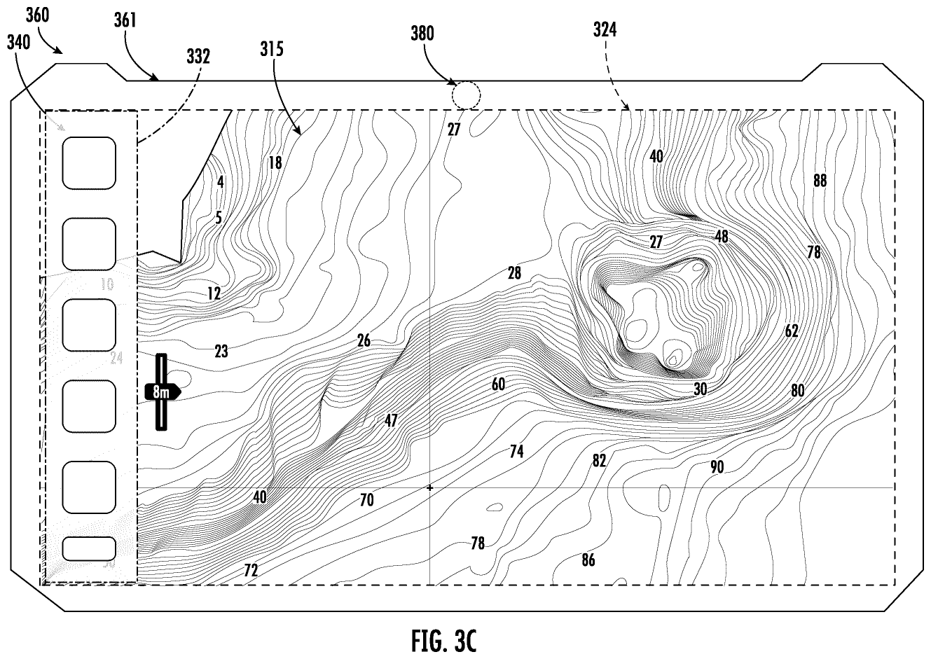

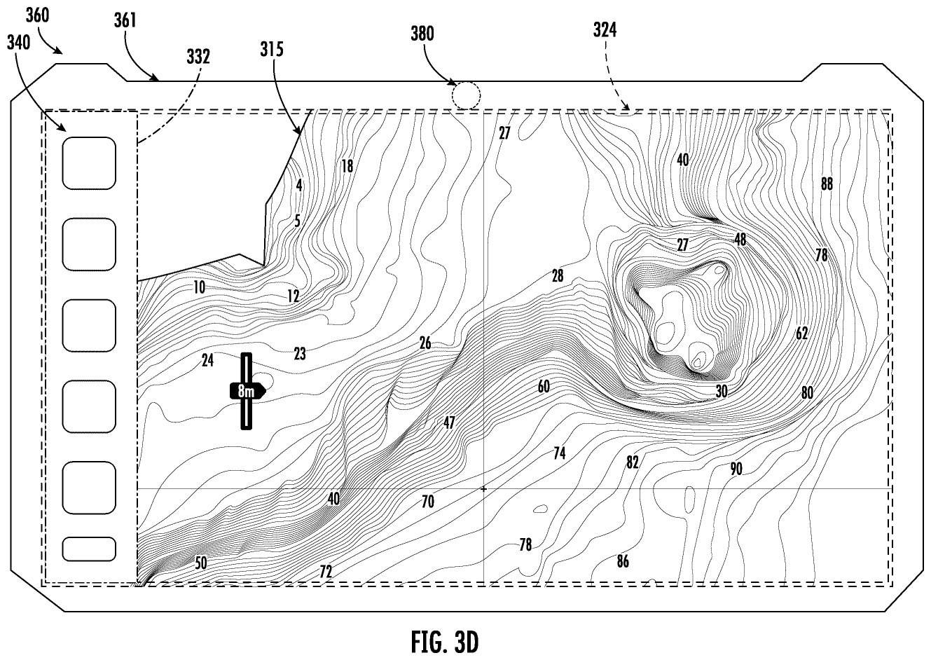

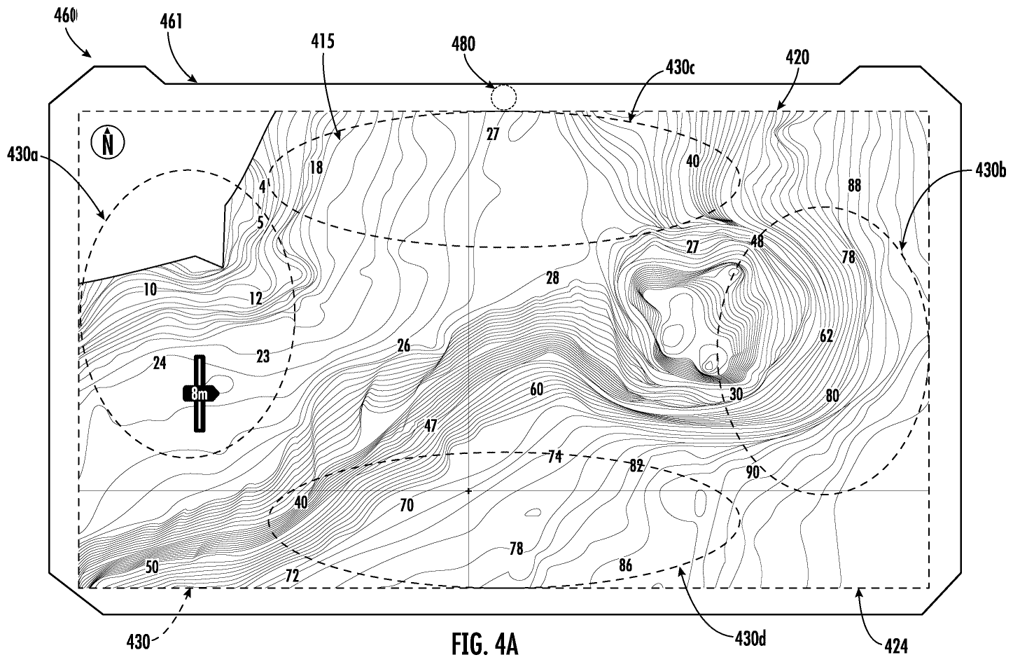

FIGS. 3A-D illustrate an example marine device 360 comprising a display 361. The display 361 may define a display area 320 which extends across the display 361. In some embodiments, the display 361 may define a sensing zone 330 which may encompass the display area 320 and may extend away from the display 361 (e.g., towards the user). In this regard, the sensing zone 330 may be a three-dimensional space. In some embodiments, the marine electronic device 360 may utilize a proximity sensor and/or a camera 380 to determine the presence of the user within the sensing zone 330.

In some embodiments, at least one image 315 may be presented on the display 361. The at least one image 315 may cover a first area 324 of the display 361, which may encompass the entire display area 320. Further, the first area 324 may cover the entire sensing area 330.

FIG. 3B illustrates the display 361 of the marine electronic device 360 upon detecting a user 310 within the sensing zone 330. In some embodiments, the display 361 may present one or more interactive menu indications (e.g., 341a, 341b, 341c, or 341d) within a first portion 324 of the display area. The interactive menu indication may include one or more of a first interactive menu indication 341a, a second interactive menu indication 341b, a third interactive menu indication 341c, or a fourth interactive menu indication 341d. Each of the interactive menu indications may correspond to an interactive menu which provides different features and/or functions. For example, the first interactive menu indication 341a may provide a first interactive menu with a list view of navigational chart options, the second interactive menu indication 341b may provide second menu with a grid of other applications available on the marine electronic device 360. In some embodiments, the third interactive menu indication 341c may provide a third menu with data information, and the fourth interactive menu indication 341d may provide a fourth menu comprising zoom ability for within the at least one image 315. It should be understood that the functionality and/or position of each of the interactive menu indications may be changed.

In some embodiments, as illustrated in FIG. 3C, upon selection of an interactive menu indication, a corresponding interactive menu 340 may be presented in at least a portion 332 of the first area 324. In some embodiments, the interactive menu 340 may be at least partially transparent so as to show the at least one image 315 below the interactive menu 340. In such embodiments, the portion 332 may be within the first area 324 of the display 361. Thus, in the illustrated embodiment, the presentation of the at least one image 315 remains the same when the interactive menu 340 is selected, and when the interactive menu 340 is hidden from the display 361. In some embodiments, the portion 332 of the first area 324 may be a side edge of the first area 324 of the display 361, while in other embodiments the portion 332 of the first area 324 may be a top edge, or a bottom edge of the first area 324 of the display 361. In some embodiments, the portion 332 of the first area 324 may be a first side edge and a second side edge of the display 361.

In some embodiments, as illustrated in FIG. 3D, the at least one image 315 may be reduced in size from the first area (e.g., 324 FIG. 3C) to a second area 326, wherein the second area 326 is smaller than the first area. In this regard, the second area 326 may be adjacent the portion 332 displaying the interactive menu 340, such that the second area 326 does not overlap with the portion 332. Reducing the at least one image 315 to cover the second area 326 prevents the interactive menu 340 from covering or hiding any useful information presented by the at least one image. Therefore, although the at least one image 315 may be smaller (e.g., does not take up the entire display area 320), the second area 326 may accurately depict the at least one image 315 and any details or information contained thereon.

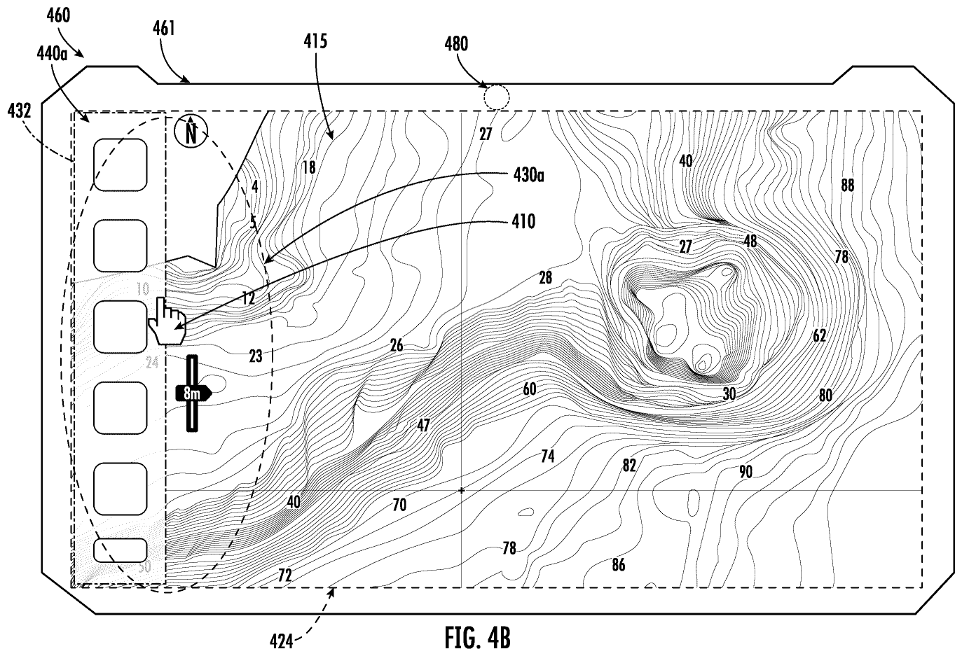

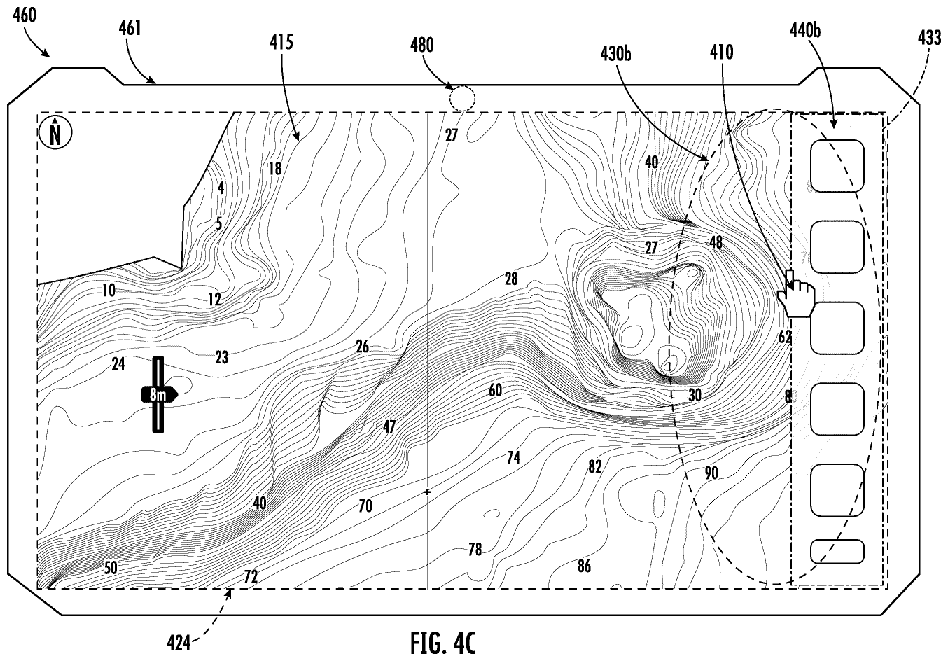

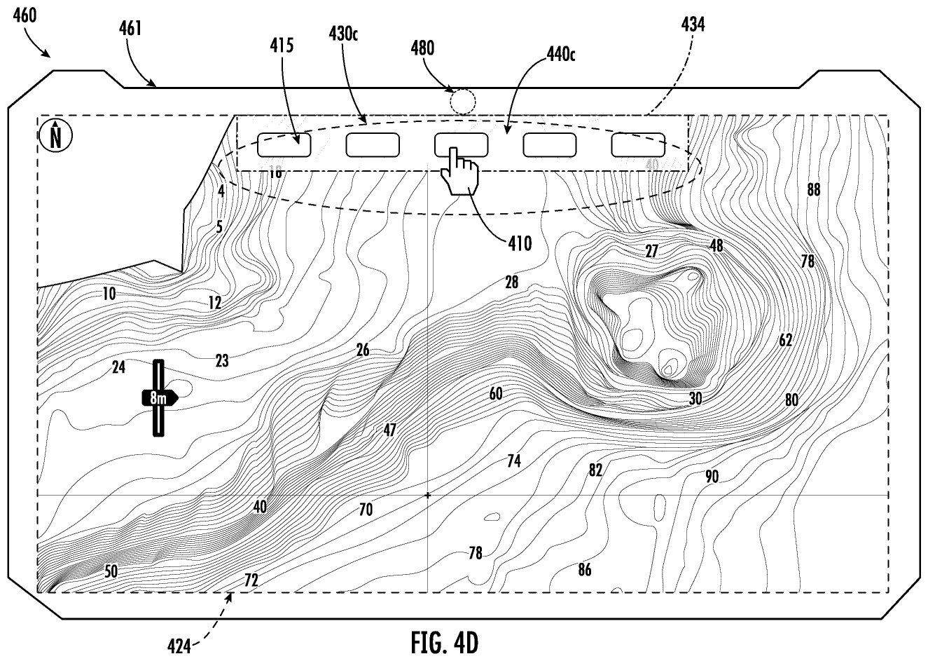

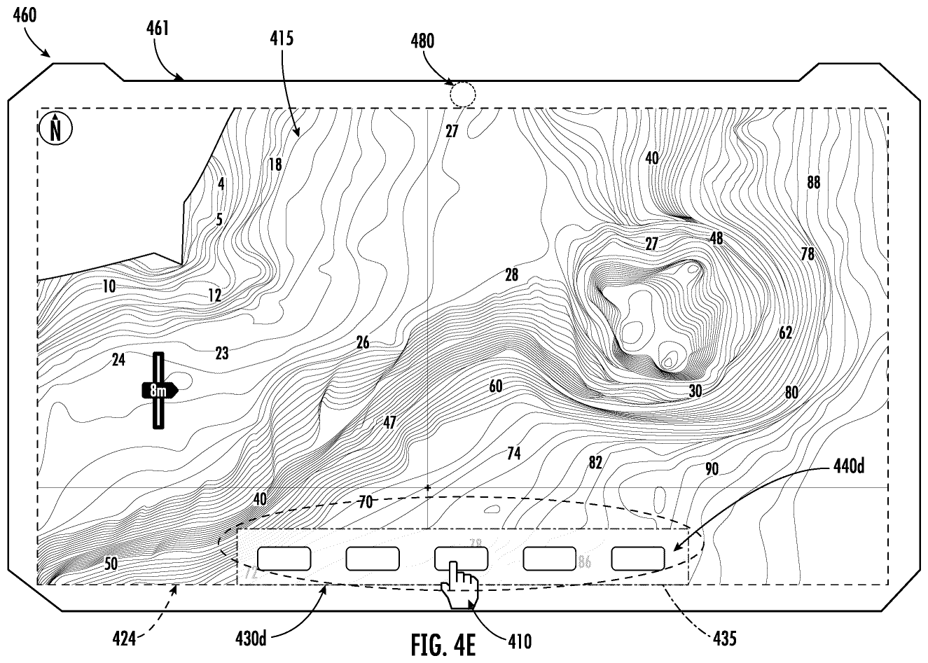

In some embodiments, the interactive menu may be tied to the sensing zone where the user is detected. As illustrated in FIGS. 4A-E a marine electronic device 460 may present at least one image 415 on a display 461. The display 461 may include at least one sensing zone 430 extending across a display area 420. In the illustrated embodiment the display area 420 may also be referred to as the first area 424. In some embodiments, the at least one sensing zone 430 may comprise different regions 430a, 430b, 430c, 430d, such that when the system detects a user (e.g., 410 FIG. 4B) within the region a corresponding interactive menu (e.g., 440) appears.

Thus, as illustrated in FIG. 4B, a user 410, when positioned over a first region 430a of the sensing zone 430, a first interactive menu 440a may appear over at least a first portion 432 of the first area 424 of the display 461.

Similarly, with reference to FIGS. 4C-E, when the user 410 is positioned over a second region 430b of the sensing zone 430, a second interactive menu 440b may appear over at least a second portion 433 of the first area 424 of the display 461; when the user 410 is positioned over a third region 430c of the sensing zone 430, a third interactive menu 440c may appear over at least a third portion 434 of the first area 424 of the display 461; and when the user is positioned over a fourth region 430d of the sensing zone 430, a fourth interactive menu 440d may appear over at least a fourth portion 435 of the first area 424 of the display 461.

In some embodiments, each of the first region 430a, second region 430b, third region 430c and the fourth region 430d may overlap, while in other embodiments each of the regions may be distinct. Therefore, in embodiments wherein the user 410 is positioned within more than one region, each of the corresponding interactive menus may appear. For example, if the user 410 is positioned over the first region 430a and the third region 430c, the first interactive menu 440a and the third interactive menu 440c may appear. Additionally, if the user 410 is positioned within the sensing zone 430 but not in a specific region, each of the interactive menus 440a, 440b, 440c, 440d may appear on the display.

In some embodiments, the interactive menus 440a, 440b, 440c, 440d may appear and disappear based on the location of the user 410. To explain, if the user 410 is positioned over the first region 430 and moves away from the first region 430a, the first interactive menu 440a may appear, while the user 410 is within the first region 430a, and disappear after a time period when the user 410 is no longer in the first region 430a. In some embodiments, the time period may be at least 5 seconds, at least 10 second, or at least 15 seconds. In some embodiments, the time period may be adjusted based on user preference.

Similarly, when the user 410 moves from one region to another region, the corresponding interactive menus may appear and disappear. For example, the user 410 may move from the first region 430a to the second region 430b, thus, the first interactive menu 440a may appear while the user 410 is within the first region 430a and may remain showing while the user 410 moves to the second region 430b. Once the user 410 is positioned in the second region 430b the second interactive menu 440b may appear. In some embodiments, the first interactive menu 440a may remain presented on the display 461 for a time period before disappearing. Thus, when the user 410 moves between two regions, each respective interactive menu may be presented simultaneously.

In some embodiments, the marine electronic device 460 may use the camera 480 to detect the user 410 and/or a gesture of the user 410. In some embodiments, the gesture may be assigned to an interactive menu 440a, 440b, 440c, 440d. For example, pointing to the left may cause presentation of the first interactive menu 440a, while pointing to the right may cause presentation of the second interactive menu 440b. In other embodiments the gesture of the user 410 may correspond to an action to be taken on the display. The action may be, for example, selecting the interactive menu 440, selecting an option from the interactive menu, removing the interactive menu, or locking the display 461.

In some embodiments, each of the interactive menus 440a, 440b, 440c, 440d may be presented as an overlay on the at least one image 415. In other embodiments, upon presentation of each of the interactive menus 440a, 440b, 440c, 440d may be presented adjacent to the at least one image 415. In this regard the presentation of the at least one image 415 may shrink such that the interactive menus 440a, 440b, 440c, and 440d are not overlaid on the at least one image 415 but are each adjacent to the at least one image 415.

Marine electronic devices may be configured to present more than one image on the display at a time. In this regard, the display may utilize a split screen configuration. In some embodiments, the split screen configuration may include two images, while in other embodiments the split screen configuration may include three or more images. In this regard, interactive menus corresponding to each of the images, may have features that are specific to that image, while other interactive menus may be generic for all or multiples of the images. For example, a sonar image may include menu options to increase the frequency, change the contrast, flip left/right, change the view, change the clarity, etc., while a navigational chart may include menu options to add a way point, start or end a route, track a route, etc.

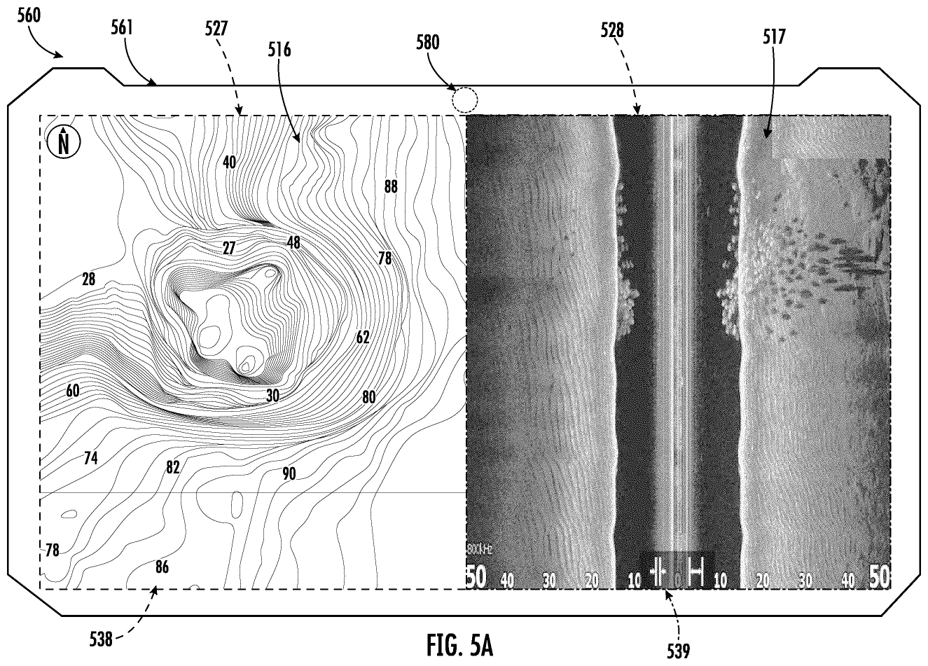

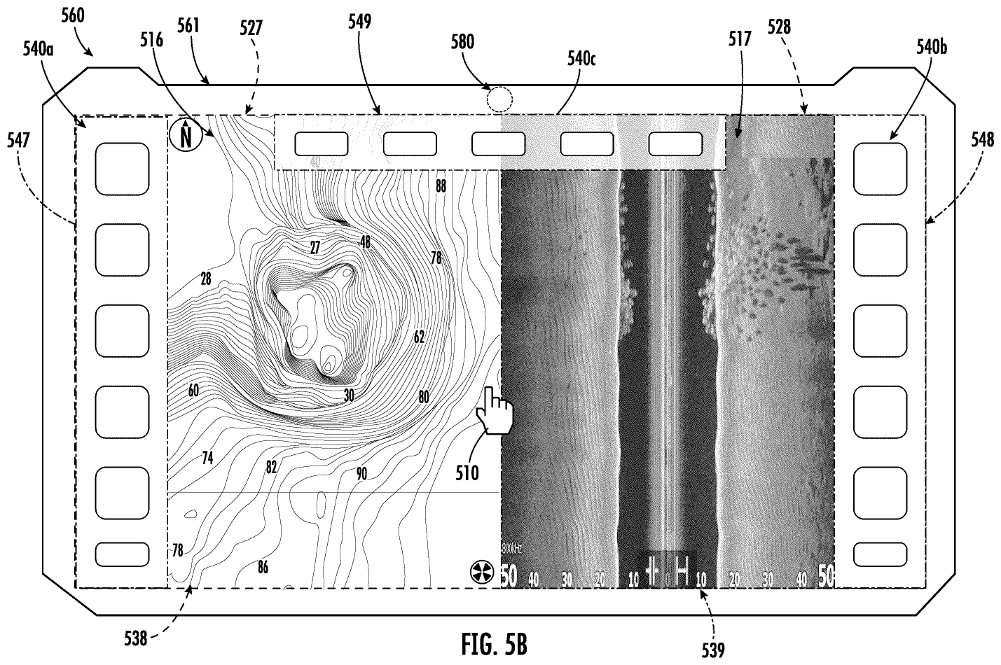

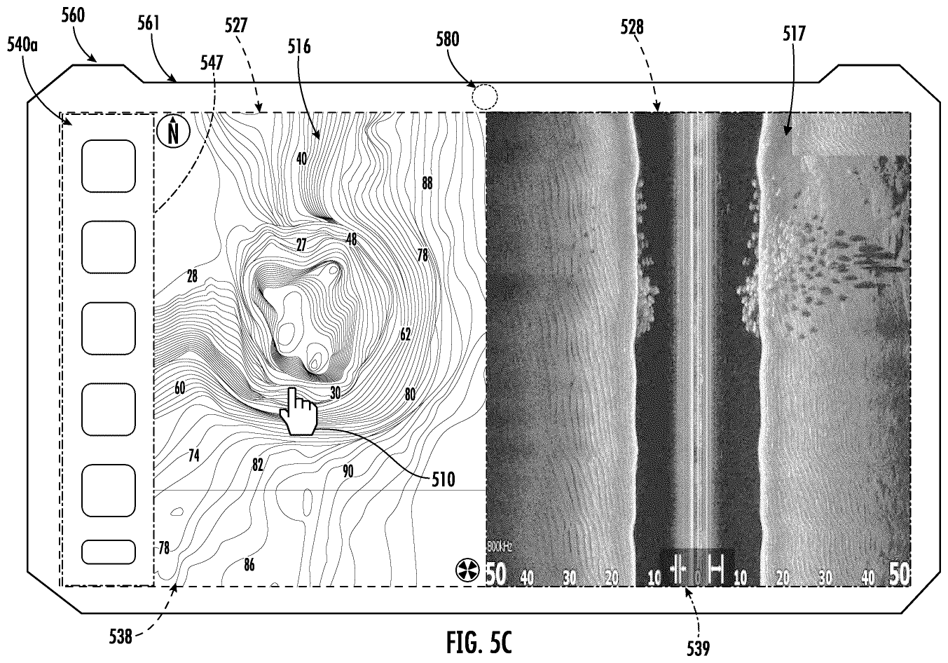

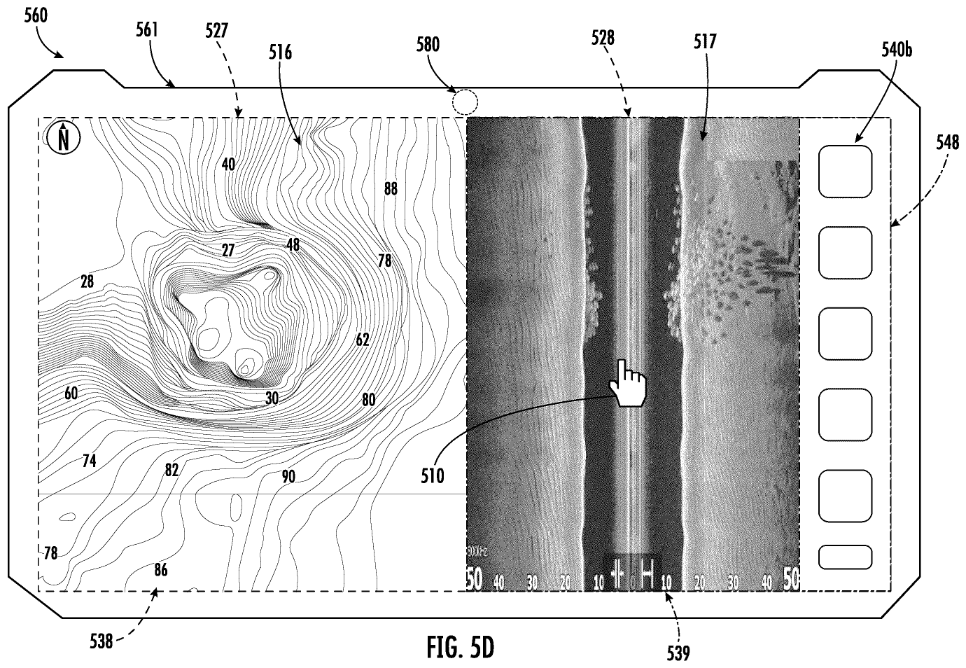

FIGS. 5A-D illustrate an example marine electronic device 560 presenting a first image 516 and a second image 517 on the display 561. The first image 516 is presented in a third area 527 of the display 561, while the second image 517 is presented in a fourth area 528 of the display 561, the third area 527 being adjacent the fourth area 528. The combination of the third area 527 and the fourth area 528 form the display area (e.g., 320 FIG. 3A). In some embodiments, the third area 527 may define a first sensing zone 538 and the fourth area 528 may define a second sensing zone 539. Each of the first sensing zone 538 and the second sensing zone 539 may cause presentation of an interactive menu within the corresponding area.

In some embodiments, such as illustrated in FIG. 5B, initial presence of a user 510 within either the first sensing zone 538 or the second sensing zone 539 may bring up multiple interactive menus, including a first interactive menu 540a, a second interactive menu 540b, and a third interactive menu 540c. In some embodiments, additional interactive menus may be presented along the display 561.

In some embodiments, the first interactive menu 540a may be presented in a first portion 547 of the third area 527, the second interactive menu 540b may be presented in a second portion 548 of the fourth area 528, and the third interactive menu 540c may be presented along a top portion 549 of the display 561. In some embodiments, the top portion 549 of the display 561 may be within each of the third area 527 and the fourth area 528. In some embodiments, each of the first interactive menu 540a, the second interactive menu 540b, and the third interactive menu 540c may be overlaid on the first image 516 and/or the second image 517.

As the user 510 moves within the first sensing zone 538 illustrated in FIG. 5C, the second interactive menu 540b and the third interactive menu 540c may disappear. In this regard the first interactive menu 540a may be presented within the third area 527 of the display 561. In some embodiments, the first interactive menu 540a may be presented as an overlay, as illustrated in FIG. 5B, while in other embodiments, the first portion 547 of the third area 527 may be distinct from the first image 516. In this regard, the first image 516 may be resized to be adjacent to the first portion 547 of the third area 527, such that the first image 516 and the first interactive menu 540a may be adjacent without overlapping.

Similarly, as the user 510 moves to the second sensing zone 528 illustrated in FIG. 5D, the first interactive menu 540a may disappear, and the second interactive menu 540b may be presented. In some embodiments, the second interactive menu 540b may be presented as an overlay, as illustrated in FIG. 5B, while in other embodiments the second interactive menu 540b may be distinct from the second image 527. In this regard, the second image 517 may be resized such that the second interactive menu 540b and the second image 517 are adjacent to and distinct from one another within the fourth area 528.

Additionally in some embodiments, the display 561 may highlight the portion of the screen where the sensor is active. To explain, the display may highlight around the area of the display 561, for example, as illustrated in FIG. 5D, the second sensing zone 539 is highlighted, as the user 510 is within the second sensing zone 539. In contrast, in FIG. 5C, the first sensing zone 539 is highlighted as the user is within the first sensing zone 538.

In some embodiments, the highlight may be a color border about the sensing zone. In other embodiments, other methods of highlighting may be used, such as, for example, a patterned border, a text indication, an image indication, etc., about or within the sensing zone.

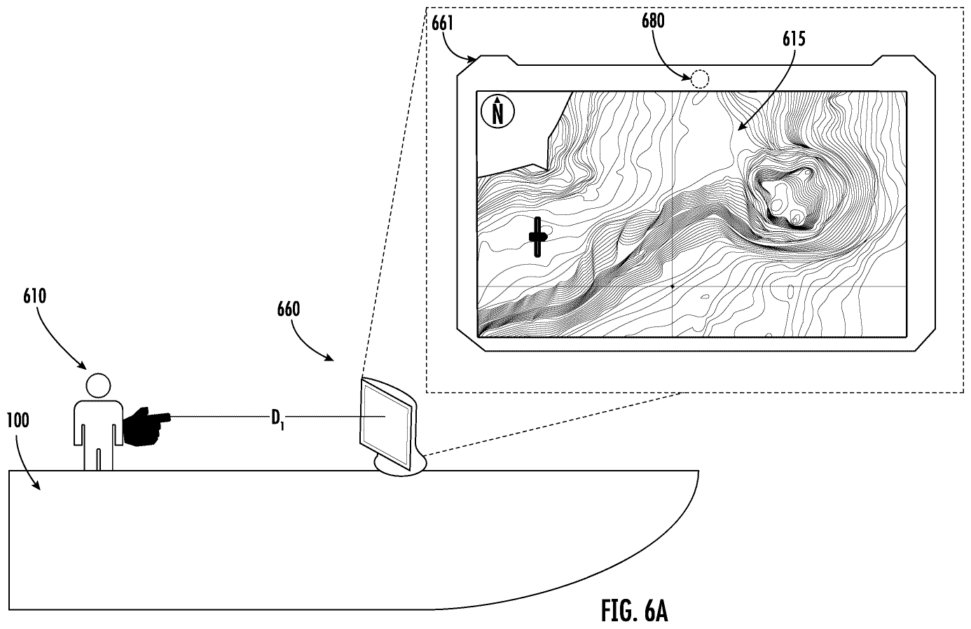

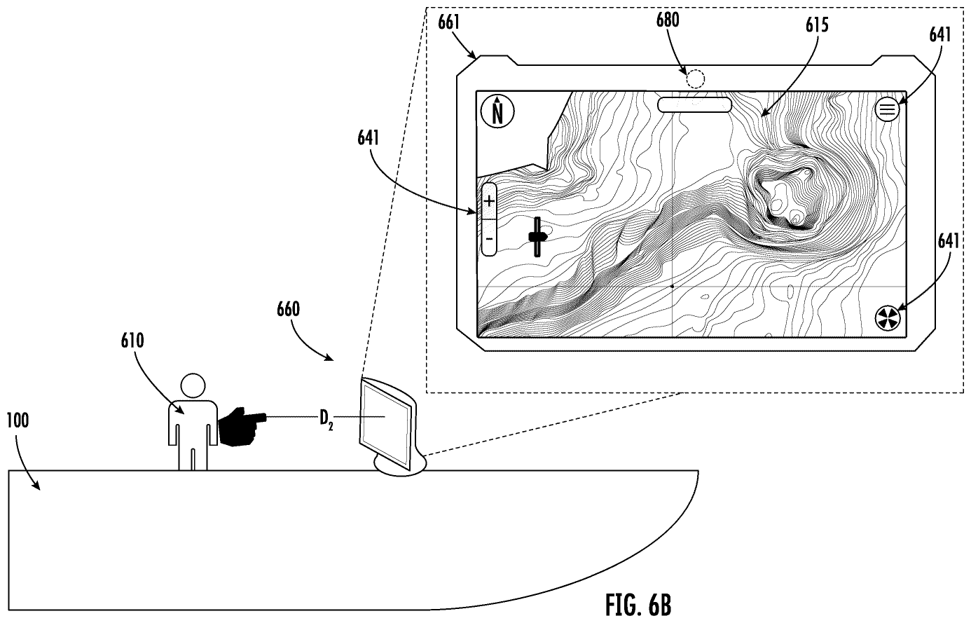

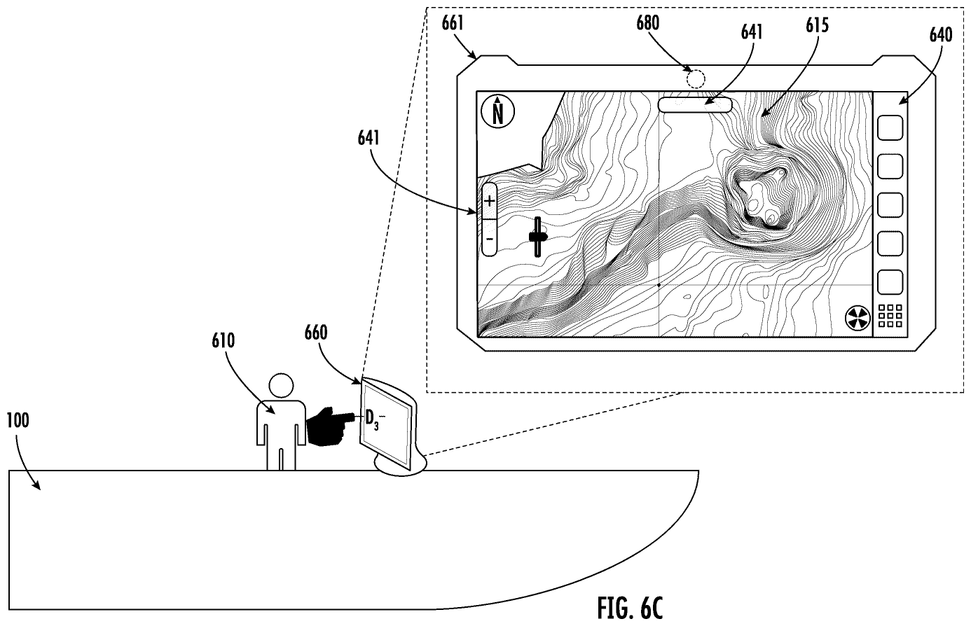

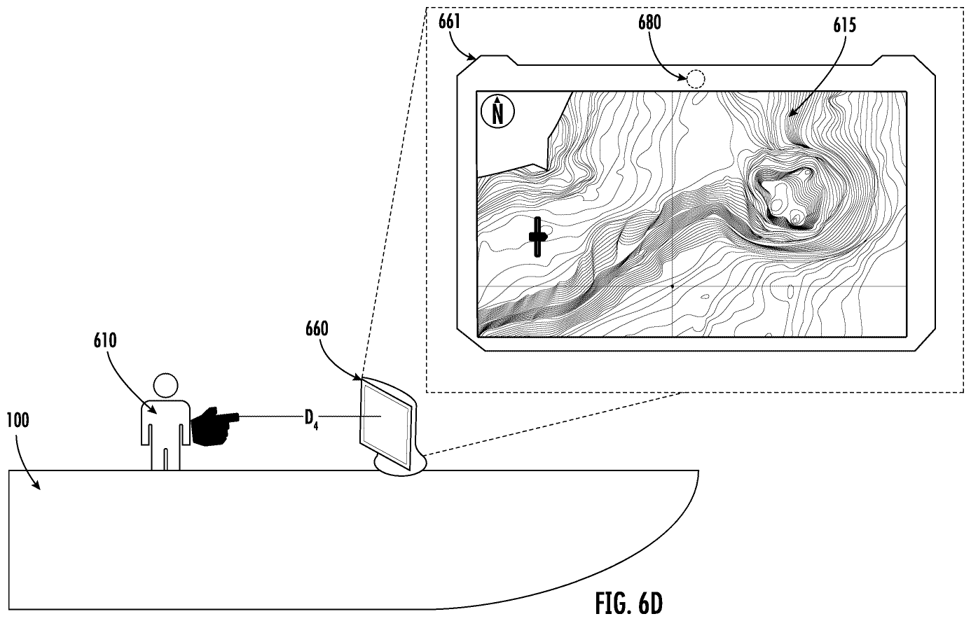

In some embodiments, a distance component may be utilized regarding determining when and/or what to present. FIGS. 6A-D illustrate a marine electronic device 660 with a display 661 within a watercraft 100 occupied by a user 610. The distance the user 610 is from the display 661 of the marine electronic device 660 corresponds to the interactive menu(s) presented on the display and may in some embodiments correspond to a sensitivity of the display 661.

FIG. 6A illustrates the user 610 in the watercraft 100 a first distance D₁ away from the marine electronic device 660. In some embodiments, the distance may be measured by a sensor, for example, a proximity sensor or a camera 680 integral to the display 661, while in other embodiments the proximity sensor or camera may be stand alone devices. At the first distance D₁, the display 661 may present at least one image 615. In this regard, the at least one image 615 covers the display area. In some embodiments, navigational aids (e.g., compass, heading directions, coordinates, etc.) may be presented on the at least one image 615, while in other embodiments, the at least one image 615 may be the only image on the display 661.

As the user 610 moves closer to the display 661, the display actions and/or the sensitivity of the display 661 (e.g., a touch screen) may change. As illustrated in FIG. 6B, the user 610 moved to a second distance D₂ away from the display 661. At the second distance D₂ the user is closer to the display 661 than at the first distance D₁. The proximity to the marine electronic device 660 may allow the user 610 to see the display 661 clearer, and the user 610 may desire to interact with the marine electronic device 660. For example, to make navigation easier using the display 661, at least one menu indication 641 may be presented on the display 661. In some embodiments, the at least one menu indication 641 may offer the user 610 a potentially desired menu and/or function. In other embodiments, the at least one menu indication 641 may indicate other potential locations to hover or to look for a menu.

In some embodiments, such as illustrated in FIG. 6C, at a third distance D₃, the user may be adjacent to and/or hovering over the display 661 (e.g., trying to interact directly with the display 661). The display 661 may be configured to present an interactive menu 640 upon the user reaching the third distance D₃. In this regard, the interactive menu 640 may be presented on the display 661 prior to the user 610 touching the display. Thus, the user 610 may view the options within the interactive menu 640 before selecting which to interact with.

After selection from the interactive menu 640 or upon retreating from the display 661 to a fourth distance D₄, the interactive menu 640 may retreat such that the at least one image 615 is presented across the entire display area as illustrated in FIG. 6D. Thus, the fourth distance D₄ is greater than the third distance D₃ and may be about the same length as the second distance D₂ and/or may be greater than the second distance D₂.

In some embodiments, in addition to or in the alternative to presenting the interactive menu 640 on the display 661, the relative distance between the user 610 and the display 661 may result in relative sensitivity of the display 661. To explain, when on a watercraft, the marine electronic device 660 may be exposed to the elements, unknowing passengers, marine life, and even pets. In order to prevent accidental interaction (e.g., with a dog's tail) the marine electronic device 660 may have variable sensitivity. In this regard, when the user 610 is at the first distance D₁, the display 661 may be the least sensitive, or may be locked, such that anything that contacts the display 661 may not cause an action to be taken. As the user 610 approaches the marine electronic device 660, the sensitivity may increase. Thus, when the user 610 is closer to the display 661 it may be easier to select and interact with the marine electronic device.

In some embodiments, the marine electronic device 660 may utilize the camera to determine if the user 610 is an authorized user. In this regard, children, or other people who are not versed in using the marine electronic device 660, may not be able to access and/or control the marine electronic device 660. To explain, the marine electronic device 660 may be configured to use the camera 680 to determine if the user 610 is authorized. If the user 610 is authorized, then the marine electronic device 660 may unlock, and allow the user 610 to interact with the marine electronic device 660. However, if the user 610 is not authorized, the marine electronic device 660 may present the at least one image 615, but not allow selection of any of the interactive menus 640.

In some circumstances, the user may wish to select the options from the interactive menus remotely. Accordingly, in some embodiments, the user may have access to a separate user input device (e.g., 165 FIG. 1). In such embodiments, when the user goes to interact with the user input device, the interactive menus may be displayed on the user input device. In some embodiments, the interactive menus may mirror the interactive menus of the display, while in other embodiments the user input device may have specific user input device menus. The user input device may be configured similar to the marine electronics device 660 such that the proximity of the user to the user input device may cause presentation of different menus on the user input device.

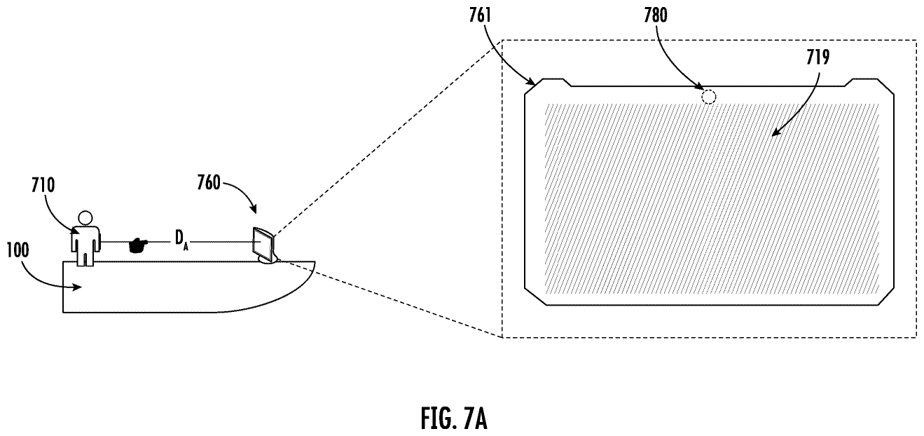

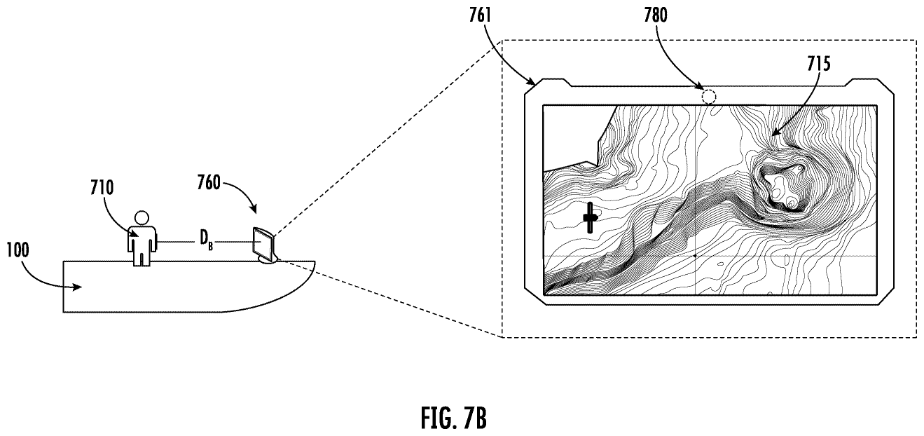

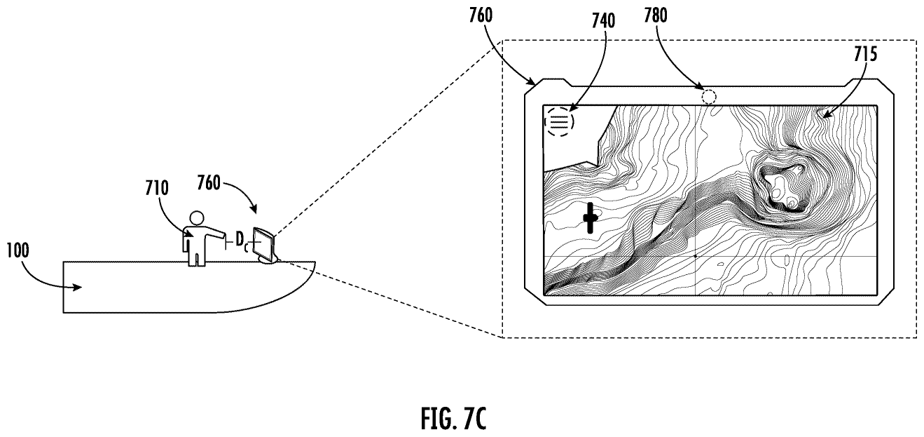

The marine electronic device may require an energy supply for power. In order to preserve the energy supply, the marine electronic device may include power saving features for when not in use. FIGS. 7A-C illustrate example power saving features of the marine electronic device.

FIG. 7A illustrates a user 710 of a marine electronic device 760 in the watercraft 100. The user 710 is a first distance DA away from a display 761 of the marine electronic device 760. In some embodiments, the first distance DA may be such that the user 710 cannot see the display 761 and/or may be unable to discern what is displayed on the display 761. Thus, to save energy, the display 761 may be in a power saving mode 719. In some embodiments, the power saving mode may dim the brightness, turn the display 761 to sleep, turn off the display 761 or similar.

Although in power save mode, the marine electronic device may be “ON”, and may be sensing the location and/or presence of the user 710 with a sensor. In some embodiments, the sensor may be a proximity sensor, while in other embodiments, the sensor may be a camera 780 built into the display 761 of the marine electronic device 760. In this regard, the camera 780 may be a user-facing camera, such that the lens is facing out the front of the display 761.

In some embodiments, the sensor may be on in the background, determining the position of the user 710. At a second distance DB, as the user 710 approaches the marine electronic device 760, as illustrated in FIG. 7B, the display 761 may “wake up” and present at least one image 715 on the display 761. At a third distance Dc, the user 710 may be adjacent to and/or hovering over (e.g., interacting directly with) the display 761 of the marine electronic device 760, and at least one interactive menu 740 may appear on the display 761. As the user 710 retreats from the marine electronic device 760 the display 761 may transition back to power save mode, as illustrated in FIG. 7A. In this regard, the display 761 may stay on for a period of time before returning to power save mode. In some embodiments, the period of time may be 1 minute, 2 minutes, 5 minutes, or even 10 minutes. In some embodiments, the period of time may be set by the user.

Similarly in some embodiments, the power save mode setting may be chosen by the user. In some embodiments, the power save mode may be entered and exited with a remote device for example, a remote, a phone, or similar. In some embodiments, the power save features may be turned on or off depending on user preference. For example, the power save features may be turned off when the user 710 is fishing and is not directly looking at the display 761. In this regard, the user 710 may be able to glance back at the display 761 and see the display without having to move closer to the display 761. The power save feature may be turned on when the display is located away from the view of the user 710 (e.g., in an engine room). Similarly, the power save feature may be turned on when the marine electronics device 760 is used overnight. In some embodiments, the marine electronics device 760 may switch the power save feature on/off at a certain time. For example, the marine electronics device 760 may turn the power save feature on one hour after sunset, two hours after sunset, or a predetermined time after sunset. Similarly, the marine electronics device 760 may turn the power save feature off one hour before sunrise, two hours before sunrise, or a predetermined time before sunrise.

In some embodiments, the user may begin interacting with the display remotely, such as through a remote device (e.g., a phone, a remote control, a foot pedal, etc.). In such situations, one or more of the above functionality related to sensing may occur instead to a button press on the remote device. For example, a button press on a remote device may cause one or more interactive menus (or interactive menu indicators) to be presented on the display, such as within the first area 324 of the display 360 (consider FIGS. 3A-3D). Likewise, all other embodiments described herein regarding presenting interactive menus (or interactive menu indicators), adjusting power savings, and/or adjusting other display settings that are performed based on a proximity of a user may be applied based on a user's interaction with a remote device. This may enable the user to adjust the screen display while being remotely located and still enabling them to “see” the interactive menus and interactive menu indicators or other information.

### Example System Architecture

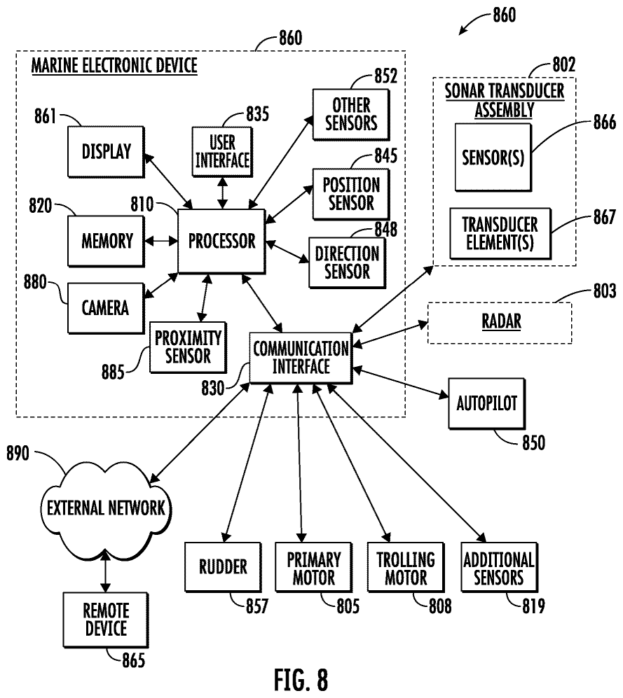

FIG. 8 illustrates a block diagram of an example system 800 according to various embodiments of the present invention described herein. The illustrated system 800 includes a marine electronic device 860. In some embodiments, the system 800 may comprise numerous marine devices. As shown in FIG. 8, one or more sonar transducer assemblies 802 (which may include one or more sensor(s) 866 in addition to one or more transducer element(s) 867), one or more radar 803, and an autopilot 850 may be provided. One or more marine devices may be implemented on the marine electronic device 860. For example, a position sensor 845, a direction sensor 848, a proximity sensor 885, a camera 880 and other sensors 852 may be provided within the marine electronic device 860. These marine devices may be integrated within the marine electronic device 860, mounted on or otherwise attached to the watercraft at another location and connected to the marine electronic device 860, and/or the marine devices may be implemented as a or on a remote device 865 in some embodiments. The system 800 may include any number of different systems, modules, or components; each of which may comprise any device or means embodied in either hardware, software, or a combination of hardware and software configured to perform one or more corresponding functions described herein.

The marine electronic device 860 may include at least one processor 810, a memory 820, a communication interface 830, a user interface 835, a display 840, autopilot 850, and one or more sensors (e.g., position sensor 845, direction sensor 848, proximity sensor 885, other sensors 852). One or more of the components of the marine electronic device 860 may be located within a housing or could be separated into multiple different housings (e.g., be remotely located).

The processor(s) 810 may be any means configured to execute various programmed operations or instructions stored in a memory device (e.g., memory 820) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the at least one processor 810 as described herein. For example, the at least one processor 810 may be configured to analyze sonar data, radar data, and/or chart data. As another example, the processor 810 may be configured to analyze sensor data to determine if a user is detected, which may include determining a relative position of the user, such as with respect to distance-wise and/or lateral-wise regarding the display 861.

In some embodiments, the at least one processor 810 may be further configured to implement signal processing. In some embodiments, the at least one processor 810 may be configured to perform enhancement features to improve the display characteristics of data or images, collect or process additional data, such as time, temperature, GPS information, waypoint designations, current, environmental conditions (e.g., wind speed, wind direction) or others, or may filter extraneous data to better analyze the collected data.

In an example embodiment, the memory 820 may include one or more non-transitory storage or memory devices such as, for example, volatile and/or non-volatile memory that may be either fixed or removable. The memory 820 may be configured to store instructions, computer program code, sonar data, radar data, chart data, and additional data such as, bathymetric data, location/position data in a non-transitory computer readable medium for use, such as by the at least one processor 810 for enabling the marine electronic device 860 to carry out various functions in accordance with example embodiments of the present invention. For example, the memory 820 could be configured to buffer input data for processing by the at least one processor 810. Additionally or alternatively, the memory 820 could be configured to store instructions for execution by the at least one processor 810.

The communication interface 830 may be configured to enable communication to external systems (e.g., an external network 890). In this manner, the marine electronic device 860 may retrieve stored data from a remote device 854 via the external network 890 in addition to or as an alternative to the onboard memory 820. Additionally or alternately, the marine electronic device 860 may store marine data locally, for example within the memory 820. Additionally or alternatively, the marine electronic device 860 may transmit or receive data, such as environmental conditions. In some embodiments, the marine electronic device 860 may also be configured to communicate with other devices or systems (such as through the external network 890 or through other communication networks, such as described herein). For example, the marine electronic device 860 may communicate with a propulsion system of the watercraft 100 (e.g., for autopilot control); a remote device (e.g., a user's mobile device, a handheld remote, etc.); or another system. Using the external network 890, the marine electronic device 860 may communicate with and send and receive data with external sources such as a cloud, server, etc. The marine electronic device 860 may send and receive various types of data. For example, the system may receive weather data, tidal data, alert data, current data, among others. However, this data is not required to be communicated using external network 890, and the data may instead be communicated using other approaches, such as through a physical or wireless connection via the communication interface 830.

The communication interface 830 of the marine electronic device 860 may also include one or more communications modules configured to communicate with one another in any of a number of different manners including, for example, via a network. In this regard, the communication interface 830 may include any of a number of different communication backbones or frameworks including, for example, Ethernet, the NMEA 2000 framework, GPS, cellular, Wi-Fi, or other suitable networks. The network may also support other data sources, including GPS, autopilot, engine data, compass, radar, etc. In this regard, numerous other peripheral devices (including other marine electronic devices or sonar transducer assemblies) may be included in the system 800.

The position sensor 845 may be configured to determine the current position and/or location associated with travel of the marine electronic device 860 (and/or the watercraft 100). For example, the position sensor 845 may comprise a GPS, bottom contour, inertial navigation system, such as machined electromagnetic sensor (MEMS), a ring laser gyroscope, or other location detection system. Additionally or alternately, the position sensor 845 may be configured to determine the orientation of the watercraft 100. Alternatively or in addition to determining the location of the marine electronic device 860 or the watercraft 100, the position sensor 845 may also be configured to determine the position and/or orientation of an object outside of the watercraft 100. In some embodiments, the position sensor 845 may be configured to determine a location associated with travel of the watercraft. For example, the position sensor 845 may utilize other sensors 852 (e.g., speed sensor, and/or direction sensor 848) to determine a future position of the watercraft 100 and/or a waypoint along the route of travel.

The proximity sensor 885 may be configured to determine the current position and/or location of a user of the watercraft in relation to the marine electronic device 860, such as described herein. In some embodiments, the proximity sensor 885 may be in data communication with the camera 880 to determine the location of the user in the watercraft. For example, the processor 810 may receive sensor data from, for example, the proximity sensor 885 and/or camera 880 and determine if a user is detected. Along these lines, in some embodiments, the processor 810 may be configured to correlate the data from the proximity sensor 885 and/or the camera 880 and determine a corresponding action. For example, the processor 810 may receive a first position from the proximity sensor 885 and determine the user is a distance from the display 861. The processor 810, may determine an action (e.g., present an indication of an interactive menu, present an interactive menu, etc.) and cause the action to present on the display 861.

The display 861 (e.g., one or more screens) may be configured to present images and may include or otherwise be in communication with a user interface 835 configured to receive input from a user. The display 861 may be, for example, a conventional LCD (liquid crystal display), a touch screen display, mobile device, or any other suitable display known in the art upon which images may be displayed.

In some embodiments, the display 861 may present one or more sets of data (or images generated from the one or more sets of data). Such data includes chart data, radar data, sonar data, weather data, location data, position data, orientation data, environmental data, sonar data, or any other type of information relevant to the watercraft. Environmental data may be received from the external network 890, retrieved from the other sensors 852, and/or obtained from sensors positioned at other locations, such as remote from the watercraft. Additional data may be received from marine devices such as a radar, a primary motor 805 or an associated sensor, a trolling motor 808 or an associated sensor, an autopilot 850, a rudder 857 or an associated sensor, a position sensor 845, a direction sensor 848, additional sensors 819, a remote device 854, onboard memory 820 (e.g., stored chart data, historical data, stored sonar data, etc.), or other devices.

The user interface 835 may include, for example, a keyboard, keypad, function keys, mouse, scrolling device, input/output ports, touch screen, or any other mechanism by which a user may interface with the system.

Although the display 861 of FIG. 8 is shown as being directly connected to the at least one processor 810 and within the marine electronic device 860, the display 861 could alternatively be remote from the at least one processor 810 and/or marine electronic device 860. Likewise, in some embodiments, the position sensor 845 and/or user interface 835 could be remote from the marine electronic device 860.

The marine electronic device 860 may include one or more other sensors/devices 852, such as configured to measure or sense various other conditions. The other sensors/devices 852 may include, for example, an air temperature sensor, a water temperature sensor, a current sensor, a light sensor, a wind sensor, a speed sensor, tide sensor, or the like.

The components presented in FIG. 8 may be rearranged to alter the connections between components. For example, in some embodiments, a marine device outside of the marine electronic device 860, such as the radar, may be directly connected to the at least one processor 810 rather than being connected to the communication interface 830. Additionally, sensors and devices implemented within the marine electronic device 860 may be directly connected to the communication interface 830 in some embodiments rather than being directly connected to the at least one processor 810.

### Example Flowchart(s) and Operations

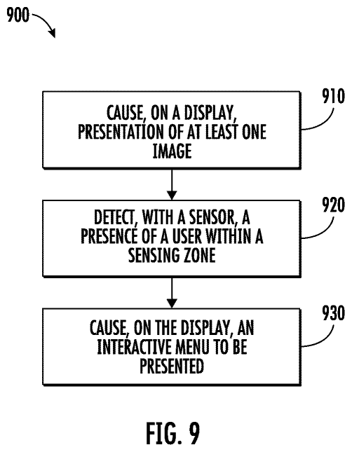

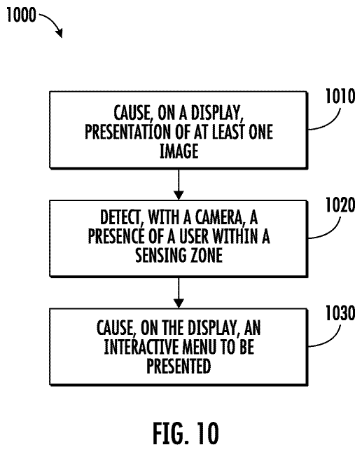

Embodiments of the present invention provide methods, apparatus and computer program products for operating according to various embodiments described herein. Various examples of the operations performed in accordance with embodiments of the present invention will not be provided with reference to FIGS. 9-10.

FIG. 9 is a flowchart illustrating an example method 900 for causing an interactive menu to be presented on a display. At operation 910, presentation of at least one image is caused on a display. At operation 920, a presence of a user within a sensing zone is detected with a sensor. In some embodiments, the sensor may be a proximity sensor. At operation 930, the interactive menu is presented on the display, in response to detecting the user in the sensing zone.

FIG. 10 is a flowchart illustrating an example method 1000 for causing an interactive menu to be displayed. At operation 1010, presentation of at least one image is caused on a display. At operation 1020, a presence of a user within a sensing zone is detected with a camera. At operation 1030, an interactive menu is presented on the display in response to detecting the user in the sensing zone.

FIGS. 9-10 illustrate flowcharts of a system, method, and computer program product according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 820 and executed by, for example, the processor 810. As will be appreciated, any such computer program product may be loaded onto a computer or other programmable apparatus (for example, a marine electronic device 860) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronic device 860) to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for presenting marine data, the system comprising:
at least one sonar transducer assembly configured to gather sonar data;
a sensor;
a display comprising a touch screen;
at least one processor; and
a memory including a computer program code, the computer program code configured to, when executed, cause the at least one processor to:
receive sonar data from the at least one sonar transducer assembly;
generate one or more sonar images based on the sonar data;
cause, on the display, presentation of the one or more sonar images, wherein the one or more sonar images covers a first area of the display, wherein the first area of the display extends at least partially across the display, wherein the display is free of any interactive menus such that imagery covers an entire available screen area of the display;
detect, with the sensor, a presence of a user within a sensing zone prior to the user providing specific user input; and
cause, on the display, in response to detecting the presence of the user within the sensing zone, an interactive menu to be presented within at least a portion of the first area of the display, wherein the interactive menu was not previously presented within the portion of the first area of the display, wherein the interactive menu is presented extending from an edge of the display and is configured to receive user input via a touch or gesture input directly thereto, wherein the at least a portion of the first area for presentation of the interactive menu is smaller than a remaining portion of the first area for presentation of the one or more sonar images.

2. The system of claim 1, wherein the sensor is a proximity sensor.

3. The system of claim 1, wherein the interactive menu is presented at least partially over the sonar image.

4. The system of claim 1, wherein the computer program code is further configured to, when executed, cause the at least one processor to:
cause, on the display, presentation of the one or more sonar images to be reduced to a second area, wherein the second area is smaller than the first area, and wherein the second area and the at least a portion of the first area of the display presenting the interactive menu do not overlap.

5. (canceled)

6. The system of claim 1, wherein the interactive menu is presented extending from a top edge of the display.

7. The system of claim 1, wherein the interactive menu is presented extending from a first side edge of the display.

8. The system of claim 1, wherein the one or more sonar images is a first image and a second image, wherein the first image covers a third area of the display corresponding to a first portion of the first area, and the second image covers a fourth area of the display corresponding to a second portion of the first area, and wherein the interactive menu is presented to extend from the edge within both the third area and the fourth area.

9. The system of claim 1, wherein the interactive menu is a first interactive menu and a second interactive menu, wherein the computer program code is further configured to, when executed, cause the at least one processor to:
cause, on the display, in response to detecting the presence of the user in a first sensing region, presentation of the first interactive menu extending from a first edge of the display; and
cause, on the display, in response to detecting the presence of the user in a second sensing region, presentation of the second interactive menu extending from a second edge of the display, wherein the first sensing region is different than the second sensing region.

10. The system of claim 1, wherein the sensing zone is a first sensing zone and a second sensing zone, wherein first sensing zone is a first distance away from the display, and wherein the second sensing zone is a second distance away from the display, wherein the first distance and the second distance are different; and
wherein the computer program code, is further configured to, when executed, cause the processor to:
cause, on the display, in response to detecting the presence of the user within the first sensing zone, presentation of an interactive menu indication; and
cause, on the display, in response to detecting the presence of the user within the second sensing zone, presentation of the interactive menu.

11. The system of claim 1, wherein the presence of the user comprises a user gesture.

12. The system of claim 1, wherein the computer program code is further configured to, when executed, cause the at least one processor to:
cause, on the display, in response to detecting a non-presence of the user, presentation of the interactive menu to cease.

13. A method of presenting marine data, the method comprising:
receiving sonar data from a sonar transducer assembly or marine chart data from a marine navigation device;
generating at least one image formed from the at least the sonar data or the marine chart data;
causing, on a display comprising a touch screen, presentation of the at least one image, wherein the at least one image covers a first area of the display, wherein the first area of the display extends at least partially across the display, wherein the display is free of any interactive menus such that imagery covers an entire available screen area of the display;
detecting, with a sensor, a presence of a user within a sensing zone prior to the user providing specific user input; and
causing, on the display, in response to detecting the presence of the user within the first sensing zone an interactive menu to be presented within at least a portion of the first area of the display, wherein the interactive menu was not previously presented within the portion of the first area of the display, wherein the interactive menu is presented extending from an edge of the display and is configured to receive user input via a touch or gesture input directly thereto, wherein the at least a portion of the first area for presentation of the interactive menu is smaller than a remaining portion of the first area for presentation of the at least one image.

14. The method of claim 13, wherein the sensor is a proximity sensor.

15. The method of claim 13, wherein the interactive menu is partially transparent.

16. The method of claim 13, wherein the presentation of the at least one image is reduced to a second area upon presentation of the interactive menu on the display in the portion of the first area, and wherein the second area and the portion of the first area are distinct.

17. The method of claim 13, wherein the interactive menu is presented extending from a bottom edge of the display.

18. The method of claim 13, wherein the at least one image is a first image and a second image, and wherein the first area is a third area and a fourth area, wherein the first image is presented within the third area and the second image is presented within the fourth area, and wherein the interactive menu is presented to extend from the edge within both the third area and the fourth area.

19. The method of claim 13, wherein the sensing zone is a first sensing region and a second sensing region, and wherein the method further comprises:
causing, on the display, in response to detecting the presence of the user in the first sensing region, presentation of a first interactive menu extending from a first edge of the display; and
causing, on the display, in response to detecting the presence of the user in the second sensing region, presentation of a second interactive menu extending from a second edge of the display, wherein the first edge is different than the second edge.

20. A system for presenting marine data, the system comprising:
at least one sonar transducer assembly configured to gather sonar data;
a user input device;
a display comprising a touch screen;
at least one processor; and
a memory including a computer program code, the computer program code configured to, when executed, cause the at least one processor to:
receive sonar data from the at least one sonar transducer assembly;
generate one or more sonar images based on the sonar data;
cause, on the display, presentation of the one or more sonar images, wherein the one or more sonar images covers a first area of the display, wherein the first area of the display extends at least partially across the display, wherein the display is free of any interactive menus such that imagery covers an entire available screen area of the display;
receive, from the user input device, indication of a user engaging the user input device prior to the user providing specific user input; and
cause, on the display, in response to engaging the user input device, an interactive menu to be presented within at least a portion of the first area of the display, wherein the interactive menu was not previously presented within the portion of the first area of the display, wherein the interactive menu is presented extending from an edge of the display and is configured to receive user input directed thereto, wherein the at least a portion of the first area for presentation of the interactive menu is smaller than a remaining portion of the first area for presentation of the one or more sonar images.

21. The system of claim 20, wherein the user input device comprises a button.

22. The system of claim 20, wherein the user input device is remotely located from the display.

23. The system of claim 20, wherein the interactive menu is presented as an overlay of the one or more sonar images.

24.-29. (canceled)
